(19) United States
(12) Patent Application Publication
(10) Pub. No.: US 2024/0269779 A1
(43) Pub. Date: Aug. 15, 2024

(54) LASER PROCESSING DEVICE AND LASER PROCESSING METHOD

(71) Applicant: KOMATSU INDUSTRIES CORPORATION, Kanazawa-shi, Ishikawa (JP)

(72) Inventors: Yoshihiro YAMAGUCHI, Kanazawa-shi, Ishikawa (JP); Nobuhiro TAKATA, Kanazawa-shi, Ishikawa (JP); Shigeru NOZAKI, Kanazawa-shi, Ishikawa (JP); Keita KONDOU, Kanazawa-shi, Ishikawa (JP)

(73) Assignee: KOMATSU INDUSTRIES CORPORATION, Kanazawa-shi, Ishikawa (JP)

(21) Appl. No.: 18/564,744

(22) PCT Filed: Apr. 28, 2022
(86) PCT No.: PCT/JP2022/019326

§ 371 Date: Nov. 28, 2023

(30) Foreign Application Priority Data
Jun. 17, 2021 (JP) 2021-100987

(51) Int. Cl. B23K 26/70; B23K 26/08; B23K 26/38

(52) U.S. Cl. CPC B23K 26/706; B23K 26/38; B23K 26/0876

(57) ABSTRACT

A container can store a transmission inhibition liquid that inhibits transmission of a laser beam. A laser head emits a laser beam. A transmittance detection sensor detects transmittance of a transmission inhibition liquid stored in a container. A liquid level sensor is fixed to the laser head, and detects a relative distance between the liquid level sensor and a liquid level of the transmission inhibition liquid. A controller controls emission of the laser beam to a workpiece by the laser head based on detection results of the transmittance detection sensor and the liquid level sensor.

### TECHNICAL FIELD

The present disclosure relates to a laser processing device and a laser processing method.

### BACKGROUND ART

Examples of the laser processing device using a fiber laser include a machine room-type fiber laser processing device and a gantry-type fiber laser processing device. A machine room-type fiber laser processing device is used when a workpiece is relatively small. In this type of processing device, an entire cutting table is covered with a machine room such that a laser beam does not leak to an outside of the device.

The gantry-type fiber laser processing device is used when the workpiece is relatively large. In this type of processing device, because the entire cutting table cannot be covered, a periphery of a laser head is covered with a cover such that the laser beam does not leak to the outside of the device.

For example, the gantry-type fiber laser processing device is disclosed in Japanese Patent No. 5940582 (PTL 1). In PTL 1, a light shielding member is attached to a lower end side of each of a laser nozzle-side cover body and a garter-side cover body. The light shielding member prevents the leakage of the laser beam from a gap between a lower end of each of the laser nozzle-side cover body and the garter-side cover body and an upper surface of a surface plate.

For example, a device using water in the laser processing device is disclosed in Japanese Patent Laying-Open No. 8-132270 (PTL 2) and Japanese Patent Laying-Open No. 62-168692 (PTL 3).

In PTL 2, the laser processing is performed in a state where a lower portion of the workpiece is immersed in cooling water in a water tank of a machining table. Thus, the entire workpiece can be cooled from below, and stable processing can be performed.

In PTL 3, the workpiece supported by a sword pin is subjected to the laser processing while water is put in a mounting box of the sword pin. The water in the water tank cools the workpiece during laser cutting to prevent scattering of dust.

### CITATION LIST

### Patent Literatures

PTL 1: Japanese Patent No. 5940582
PTL 2: Japanese Patent Laying-Open No. 8-132270
PTL 3: Japanese Patent Laying-Open No. 62-168692

### SUMMARY OF INVENTION

### Technical Problem

In the laser processing device described in PTL 1, there is a risk that the laser beam penetrates the workpiece to leak to the outside of the device by being reflected in the cutting table below the workpiece. In order to prevent the leakage of the laser beam, a cutting table-side light shielding member is required to be installed below the workpiece. For this reason, a structure of the laser processing device becomes complicated.

Furthermore, in PTL 1, the cutting table-side light shielding member disposed below the workpiece is scraped off little by little by the laser beam. For this reason, light shielding becomes not perfect as time elapses, and the laser beam leaks to the outside of the device.

Furthermore, in PTLs 2 and 3, the water in the water tank is used for the purpose of cooling the workpiece or preventing the scattering of the dust, and the light shielding of the laser beam is not considered.

An object of the present disclosure is to provide a laser processing device and a laser processing method capable of preventing the leakage of the laser beam to the outside with a simple device configuration.

### Solution to Problem

A laser processing device of the present disclosure is a laser processing device processing a workpiece using a laser beam, the laser processing device including a container, a laser head, a transmittance detection sensor, a liquid level sensor, and a controller. The container can store a transmission inhibition liquid inhibiting transmission of the laser beam. The laser head emits the laser beam. The transmittance detection sensor detects transmittance of a transmission inhibition liquid stored in the container. The liquid level sensor is fixed to the laser head, and detects a relative distance between the liquid level sensor and a liquid level of the transmission inhibition liquid. The controller controls emission of the laser beam to the workpiece by the laser head based on detection results of the transmittance detection sensor and the liquid level sensor.

A laser processing method of the present disclosure is a laser processing method for processing a workpiece placed on a placement unit in a container using a laser beam emitted from the laser head, the laser processing method including the following steps.

A transmission inhibition liquid inhibiting transmission of the laser beam is stored in the container. Transmittance of the transmission inhibition liquid stored in the container is detected. A liquid level position of the transmission inhibition liquid with respect to the laser head is detected. The emission of the laser beam to the workpiece by the laser head is controlled based on the detection result of the transmittance of the transmission inhibition liquid and the detection result of the liquid level position of the transmission inhibition liquid.

### Advantageous Effects of Invention

According to the present disclosure, the laser processing device and the laser processing method capable of preventing the leakage of the laser beam to the outside can be implemented with the simple device configuration.

### BRIEF DESCRIPTION OF DRAWINGS

FIG. 1 is a perspective view illustrating a configuration of a laser processing device according to an embodiment.

FIG. 2 is a sectional perspective view illustrating an internal configuration of a container used in the laser processing device of FIG. 1.

FIG. 3 is a sectional view illustrating a configuration of a laser head used in the laser processing device of FIG. 1.

FIG. 4 is a sectional view illustrating a configuration of a laser beam shielding member used in the laser processing device of FIG. 1.

FIG. 5 is a sectional view illustrating a configuration of a liquid level adjustment mechanism used in the laser processing device of FIG. 1.

FIG. 6 is a functional block diagram illustrating a controller in FIG. 5.

FIG. 7 is a flowchart illustrating a laser processing method of the embodiment.

FIG. 8 is a sectional perspective view illustrating how a workpiece is subjected to laser processing.

### DESCRIPTION OF EMBODIMENT

With reference to the drawings, an embodiment of the present disclosure will be described in detail below. In the specification and the drawings, the same components or corresponding components are denoted by the same reference numerals, and redundant description will not be repeated. In the drawings, the construction may be omitted or simplified for convenience of description.

### <Construction of Laser Processing Device>

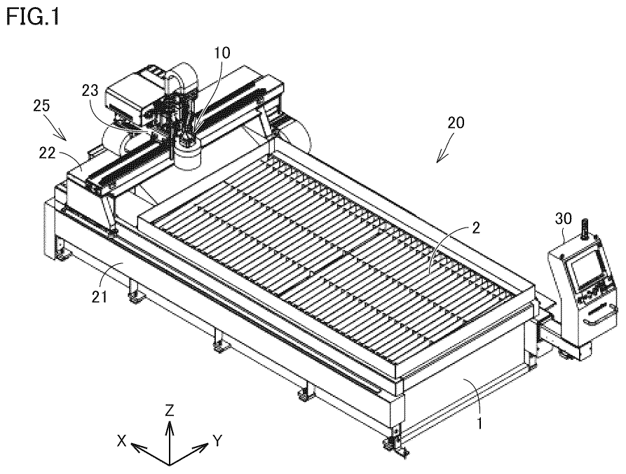

With reference to FIGS. 1 to 5, a construction of a laser processing device according to an embodiment will be described below.

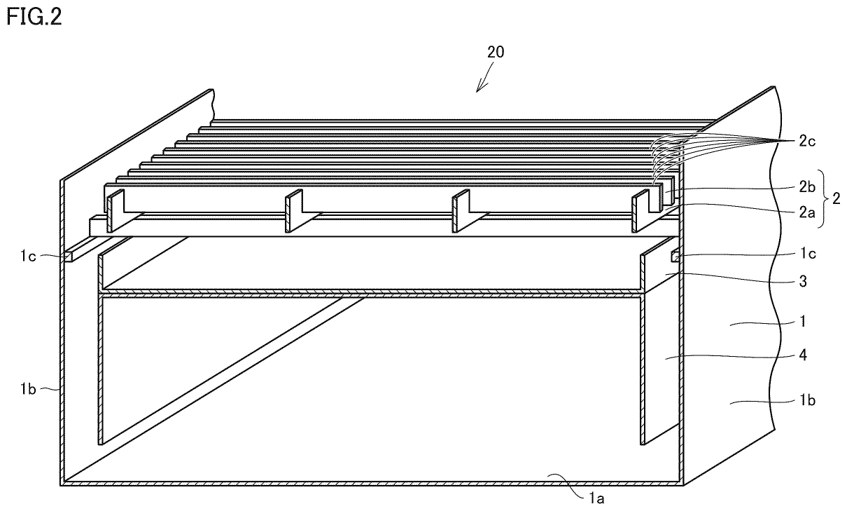

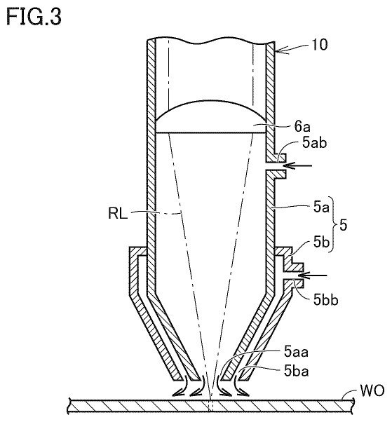

FIG. 1 is a perspective view illustrating the construction of the laser processing device of the embodiment. FIG. 2 is a sectional perspective view illustrating an internal construction of a container used in the laser processing device of FIG. 1. FIGS. 3, 4, and 5 are sectional views illustrating constructions of a laser head, a laser beam shielding member, and a liquid level adjustment mechanism used in the laser processing device of FIG. 1.

As illustrated in FIGS. 1 and 2, a laser processing device 20 of the embodiment mainly includes a container 1, a cutting pallet 2 (support member), a sludge tray 3, a liquid level adjustment tank 4, a laser head 10, a drive mechanism 25, and an operation panel 30.

As illustrated in FIG. 2, container 1 includes a rectangular bottom wall 1a and four side walls 1b rising from each of four sides of bottom wall 1a. Container 1 has a bottomed cylindrical shape with an open top. Container 1 includes an opening at an upper end and an internal space extending from the opening to an inside of container 1.

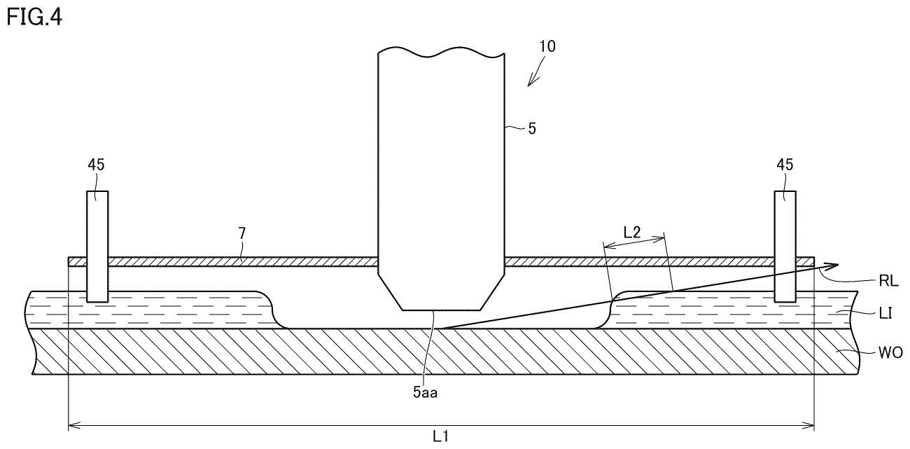

Container 1 is configured to be able to store a liquid (transmission inhibition liquid LI: FIG. 4) therein. A pallet support 1c is provided in side wall 1b. Pallet support 1c protrudes laterally from a wall surface of side wall 1b toward the internal space of container 1.

Liquid level adjustment tank 4 is disposed in the internal space of container 1. Liquid level adjustment tank 4 has a box shape including an opening at a lower end. Through this opening, the internal space of liquid level adjustment tank 4 is connected to the internal space of container 1.

Liquid level adjustment tank 4 is constructed to be able to store gas in the internal space of liquid level adjustment tank 4. The gas can be supplied to or discharged from the internal space of liquid level adjustment tank 4. Transmission inhibition liquid LI in liquid level adjustment tank 4 can be pushed out of liquid level adjustment tank 4 by supplying the gas into the internal space of liquid level adjustment tank 4. Transmission inhibition liquid LI can be taken in from the outside to the inside of liquid level adjustment tank 4 by discharging the gas from the internal space of liquid level adjustment tank 4. Thus, the liquid level in container 1 can be adjusted.

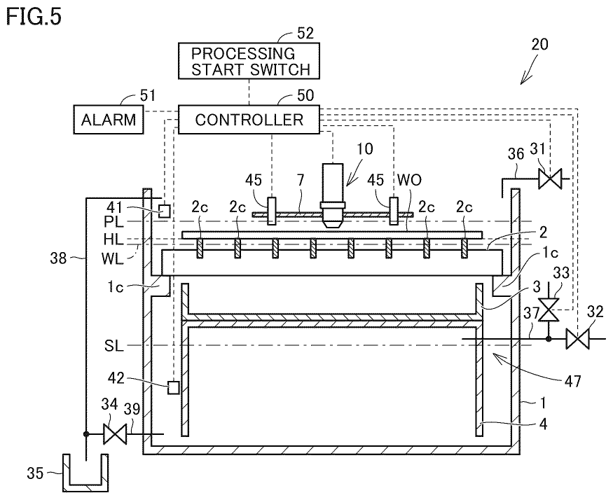

Sludge tray 3 is disposed above liquid level adjustment tank 4. Sludge tray 3 has a box shape including the opening at the upper end. Sludge tray 3 can accumulate sludge generated when the workpiece is cut by the laser processing. The sludge generated during the laser processing falls from a workpiece WO (FIG. 5) and is accumulated inside sludge tray 3 through the opening at the upper end of sludge tray 3.

Cutting pallet 2 is supported by container 1 using pallet support 1c. Cutting pallet 2 is disposed in the interior space of container 1 and above sludge tray 3. Cutting pallet 2 includes a plurality of first support plates 2a and a plurality of second support plates 2b. The plurality of first support plates 2a and the plurality of second support plates 2b are assembled in a lattice shape by being arranged vertically and horizontally.

Cutting pallet 2 includes a placement unit 2c that supports a lower surface of workpiece WO (FIG. 5). For example, placement unit 2c of cutting pallet 2 is constructed by an upper end of each of the plurality of second support plates 2b. Placement unit 2c is located at a position lower than the upper end of container 1 (the upper end of side wall 1b). The upper end of container 1 is located at a position higher than the upper surface of workpiece WO while workpiece WO is placed on placement unit 2c. Thus, when container 1 is filled with transmission inhibition liquid LI while workpiece WO is placed on placement unit 2c, a liquid level of transmission inhibition liquid LI can be made higher than the upper surface of workpiece WO.

As illustrated in FIG. 1, drive mechanism 25 moves laser head 10 in the X-direction (longitudinal direction of container 1), the Y-direction (lateral direction of container 1), and the Z-direction (vertical direction). Drive mechanism 25 mainly includes a pair of left and right support bases 21, an X-direction movable base 22, a Y-direction movable base 23, and laser head 10.

The pair of left and right support bases 21 is disposed so as to sandwich container 1 in the Y-direction. The pair of left and right support bases 21 extends in the X-direction. X-direction movable base 22 is disposed across the pair of left and right support bases 21 by extending in the Y-direction. X-direction movable base 22 is driven in the X-direction along the support base 21 by an X-axis motor (not illustrated).

Y-direction movable base 23 is supported to be movable in the Y-direction with respect to X-direction movable base 22 by, for example, a rack and pinion mechanism. Y-direction movable base 23 is driven in the Y-direction by a Y-axis motor (not illustrated).

Laser head 10 is supported to be movable in the Z-direction with respect to Y-direction movable base 23 by, for example, a rack and pinion mechanism. Laser head 10 is driven in the Z-direction by a Z-axis motor (not illustrated).

Operation panel 30 receives input of a processing condition such as a plate thickness, a material, and a speed of workpiece WO. Operation panel 30 includes a display, a switch, and an alarm. The display displays an input screen of the machining condition, a screen indicating an operating status of laser processing device 20, and the like.

As illustrated in FIG. 3, laser head 10 mainly includes a head body 5 and a condensing lens 6a. Head body 5 includes a body 5a.

Body 5a has a hollow cylindrical shape. Condensing lens 6a is accommodated in body 5a. Condensing lens 6a condenses a laser beam RL on workpiece WO. Laser beam RL condensed by condensing lens 6a is emitted from a laser emission port 5aa (emission unit) of body 5a toward workpiece WO.

Laser beam RL used in laser processing device 20 of the embodiment has any wavelength of visible light, near-infrared light, mid-infrared light, and far-infrared light, and has a wavelength greater than or equal to 0.7 μm and less than or equal to 10 m. For example, laser beam RL is a laser beam using fiber laser as a light source, and may be a laser beam using solid-state laser containing Yttrium Aluminum Garnet (YAG) as a light source. The fiber laser is a type of solid-state laser using an optical fiber as an amplification medium. In the fiber laser, a core located at the center of the optical fiber is doped with rare earth element Yb (ytterbium). Laser beam RL using the fiber laser as a light source is near-infrared light having a wavelength of about 1.06 m. Running cost and maintenance cost of the fiber laser are lower than those of a carbon dioxide laser.

Body 5a includes a gas outlet 5aa and a gas supply unit 5ab. An assist gas is supplied from gas supply unit 5ab into body 5a. The assist gas supplied into body 5a is blown out from gas outlet 5aa toward workpiece WO. Gas outlet 5aa also serves as a laser emission port 5aa.

Head body 5 may further include an outer nozzle 5b. Outer nozzle 5b is attached to body 5a so as to surround the periphery of gas outlet 5aa of body 5a. A gap space is provided between the inner peripheral surface of outer nozzle 5b and the outer peripheral surface of body 5a.

Outer nozzle 5b includes a gas outlet 5ba and a gas supply unit 5bb. Each of gas outlet 5ba and gas supply unit 5bb is connected to the gap space. Gas outlet 5ba is disposed on an outer periphery of gas outlet 5aa, and has an annular shape.

The secondary gas (shielding gas) is supplied from gas supply unit 5bb to the gap space between body 5a and outer nozzle 5b. The secondary gas supplied into the gap space is blown out from gas outlet 5ba toward workpiece WO. Thus, the secondary gas is blown out from gas outlet 5ba onto the outer peripheral side of the assist gas blown out from gas outlet 5aa.

As described above, laser head 10 has gas outlets 5aa, 5ba. Gas outlets 5aa, 5ba may include gas outlet 5aa through which the assist gas is blown out and gas outlet 5ba through which the secondary gas is blown out. Gas outlet 5aa and gas outlet 5ba form a double nozzle structure.

As illustrated in FIG. 4, laser head 10 includes a laser beam shielding member 7. Laser beam shielding member 7 surrounds the periphery of laser head 10. For example, laser beam shielding member 7 is made of a metal plate having rigidity. For example, laser beam shielding member 7 is a plate member 7. For example, plate member 7 has an annular shape. Plate member 7 is attached to head body 5 by a fixing member (not illustrated) such as a bolt. Plate member 7 extends from the position where plate member 7 is attached to head body 5 about gas outlet 5aa in planar view onto the outer peripheral side. Thus, plate member 7 surrounds the periphery of laser emission port 5aa of laser head 10.

For example, plate member 7 may be made of a carbon plate. The lower surface (the surface opposite to workpiece WO) of plate member 7 may be black so as to easily absorb the laser beam. A reflector may be attached to the lower surface of plate member 7. Alternatively, a carbon sheet or a rubber sheet may be attached to the lower surface of metal plate member 7.

Plate member 7 absorbs or reflects the laser beam emitted from laser emission port 5aa of head body 5 and reflected by workpiece WO. The laser beam is absorbed by plate member 7, whereby intensity of laser beam is reduced. In addition, the laser beam is reflected by plate member 7 and passes through transmission inhibition liquid LI, whereby the intensity of the laser beam is reduced. Thus, the leakage of the laser beam is prevented from between plate member 7 and workpiece WO.

Furthermore, as indicated by an arrow RL in the drawing, there is the laser beam that does not hit plate member 7 but leaks to the outside from the gap between plate member 7 and workpiece WO. A dimension (diameter L1) of plate member 7 is set such that the laser beam passes through transmission inhibition liquid LI by a predetermined distance L2. When the laser beam passes through transmission inhibition liquid LI by predetermined distance L2, the intensity of the laser beam is sufficiently reduced. Thus, the leakage of the laser beam is prevented from between plate member 7 and workpiece WO.

In the embodiment, a liquid level sensor 45 is fixed to laser head 10. For example, liquid level sensor 45 is fixed to laser head 10 with laser beam shielding member 7 interposed therebetween. For example, two liquid level sensors 45 may be attached to laser beam shielding member 7. Each of two liquid level sensors 45 detects a height position of a liquid level of transmission inhibition liquid LI with respect to laser head 10.

As illustrated in FIG. 5, a supply pipe 36 is provided in order to supply transmission inhibition liquid LI (FIG. 4) into container 1. A supply valve 31 is attached to supply pipe 36. The supply of transmission inhibition liquid LI to the internal space of container 1 is started by opening supply valve 31, and the supply of transmission inhibition liquid LI to the internal space of container 1 is stopped by closing supply valve 31.

A gas pipe 37 is connected to the liquid level adjustment tank 4 from the outside of container 1. A pressurizing valve 32 and a pressure reducing valve 33 are attached to gas pipe 37. The gas is supplied into liquid level adjustment tank 4 when pressurizing valve 32 is opened, and the supply of the gas into liquid level adjustment tank 4 is stopped when the pressurizing valve 32 is closed. The gas in liquid level adjustment tank 4 is discharged to the outside by opening pressure reducing valve 33, and the discharge of the gas from liquid level adjustment tank 4 is stopped by closing pressure reducing valve 33. Liquid level adjustment tank 4, gas pipe 37, pressurizing valve 32, and pressure reducing valve 33 are included in a liquid level adjustment mechanism 47. As described later, liquid level adjustment mechanism 47 adjusts the liquid level of transmission inhibition liquid LI in container 1 based on a detection result of a liquid level detection sensor 41.

An overflow pipe 38 is attached to container 1. When the liquid level of transmission inhibition liquid LI in container 1 becomes greater than or equal to a predetermined liquid level, transmission inhibition liquid LI in container 1 is discharged to a liquid storage tank 35 through overflow pipe 38. Liquid storage tank 35 is disposed outside container 1.

A liquid discharge pipe 39 is attached to container 1. A discharge valve 34 is attached to liquid discharge pipe 39. Transmission inhibition liquid LI in container 1 is discharged to liquid storage tank 35 by opening discharge valve 34, and the discharge of transmission inhibition liquid LI from container 1 is stopped by closing discharge valve 34.

Container 1 is configured to be capable of storing transmission inhibition liquid LI at least up to a height position HL of placement unit 2c. Container 1 is capable of storing transmission inhibition liquid LI up to a position PL higher than the upper surface of workpiece WO placed on placement unit 2c.

Transmission inhibition liquid LI stored in container 1 inhibits transmission of the laser beam. For example, transmission inhibition liquid LI inhibits the transmission of the light having a wavelength greater than or equal to 0.7 μm and less than or equal to 10 μm.

For example, the transmittance of the light in a wavelength range greater than or equal to 0.7 μm and less than or equal to 10 μm in transmission inhibition liquid LI is less than or equal to 10%/cm. For example, the transmittance of the light in the wavelength range greater than or equal to 0.7 μm and less than or equal to 10 μm in transmission inhibition liquid LI is preferably less than or equal to 5%/cm. For example, the transmittance of the light in the wavelength range greater than or equal to 0.7 μm and less than or equal to 10 μm in transmission inhibition liquid LI is more preferably less than or equal to 3%/cm.

Transmission inhibition liquid LI contains an additive that absorbs or scatters the light in the wavelength range greater than or equal to 0.7 μm and less than or equal to 10 μm in order to inhibit the transmission of the light in the wavelength range greater than or equal to 0.7 μm and less than or equal to 10 μm. For example, this additive contains carbon. The additive is preferably black. For example, transmission inhibition liquid LI is an aqueous solution obtained by adding carbon to water. For example, transmission inhibition liquid LI is an aqueous solution obtained by adding 0.1 vol % of India ink to water. The water in the present specification may be tap water or pure water. The India ink is obtained by dispersing carbon black (carbon) in an aqueous solution of glue or another water-soluble resin, and a mixing ratio of the carbon black is 4.0 wt % to 20.0 wt %, preferably 5.0 wt % to 10.0 wt % with respect to the total amount. For example, the India ink is commercially available “Kuretake concentrated ink Bokuteki BA7-18”.

Transmission inhibition liquid LI preferably contains a rust inhibitor. The rust inhibitor is a corrosion inhibitor that inhibits corrosion of a steel material or the like. For example, the rust inhibitor is water-soluble. For example, a precipitated film type inhibitor, a passive type inhibitor, or a deoxygenated type inhibitor may be used as the rust inhibitor.

Laser processing device 20 further includes liquid level detection sensor 41, a transmittance detection sensor 42, liquid level sensor 45, a controller 50, an alarm 51, and a processing start switch 52.

Liquid level detection sensor 41 is installed in container 1 and has a function of detecting the liquid level of transmission inhibition liquid LI stored in container 1. For example, liquid level detection sensor 41 is a guide pulse type level sensor.

Transmittance detection sensor 42 is installed in container 1 and has a function of detecting the transmittance of transmission inhibition liquid LI. Concentration of an additive (for example, carbon) contained in transmission inhibition liquid LI can be known by detecting the transmittance of transmission inhibition liquid LI using transmittance detection sensor 42. For example, transmittance detection sensor 42 is a transmission type laser discrimination sensor. Transmittance detection sensor 42 includes a light emission unit that emits detection light (for example, laser beam) and a light reception unit that receives the detection light emitted from the light emission unit. Transmittance detection sensor 42 may include a light emission unit that emits the detection light and a reflection unit that reflects the detection light emitted from the light emission unit. The detection light reflected by the reflection unit may be received by the light emission unit, or be received by a light reception unit separate from the light emission unit.

Liquid level sensor 45 is fixed to laser head 10 and installed so as to be movable integrally with laser head 10. Liquid level sensor 45 detects a distance (relative distance) between a tip of liquid level sensor 45 and the liquid level of transmission inhibition liquid LI, and outputs a signal thereof. Liquid level sensor 45 is configured to be turned on, for example, when the liquid level of transmission inhibition liquid LI comes to the height position where liquid level sensor 45 is set. The height position of the liquid level of transmission inhibition liquid LI with respect to laser head 10 can be detected based on the signal output from liquid level sensor 45. For this reason, for example, when the lower end of laser head 10 is located below the lower end of liquid level sensor 45, it is detected that the lower end of laser head 10 is located below the height position of the liquid level of transmission inhibition liquid LI by detecting that liquid level sensor 45 is located immediately above the liquid level of transmission inhibition liquid LI.

A liquid level sensor that detects the liquid level in a non-contact manner using capacitance, a liquid level sensor that is configured by two electrodes and directly detects the liquid level by energization, or the like can be used as liquid level sensor 45.

Alarm 51 reports the state of laser processing device 20 to the outside by display, sound, or the like. Alarm 51 may be a warning light, a display, or a speaker provided on operation panel 30 (FIG. 1). Processing start switch 52 issues an instruction to start the laser processing by laser processing device 20 by an external operation. Processing start switch 52 may be provided on operation panel 30. Processing start switch 52 may be a touch panel provided on operation panel 30.

Controller 50 controls to open and close supply valve 31, pressurizing valve 32, pressure reducing valve 33, and discharge valve 34. Although a line connecting controller 50 and discharge valve 34 is not illustrated in FIG. 5, this is for simplification of the drawing. Controller 50 controls movement of laser head 10 in the X-, Y-, and Z-directions, laser irradiation from laser head 10, and the like. Controller 50 controls the notification of alarm 51.

Controller 50 receives a signal indicating the liquid level of transmission inhibition liquid LI in container 1 detected by liquid level detection sensor 41. Controller 50 receives a signal indicating the transmittance of transmission inhibition liquid LI detected by transmittance detection sensor 42. Controller 50 receives a signal indicating the liquid level of transmission inhibition liquid LI with respect to laser head 10 detected by liquid level sensor 45. Controller 50 receives a signal indicating a processing start instruction by processing start switch 52.

Controller 50 controls opening and closing of pressurizing valve 32 or pressure reducing valve 33 based on the detection result of liquid level detection sensor 41. Thus, an amount of gas stored in liquid level adjustment tank 4 is adjusted, and the liquid level of transmission inhibition liquid LI stored in container 1 is adjusted. In this manner, controller 50 controls the opening and closing of pressurizing valve 32 or pressure reducing valve 33 such that the liquid level adjustment mechanism (liquid level adjustment tank 4, gas pipe 37, pressurizing valve 32, and pressure reducing valve 33) adjusts the liquid level of transmission inhibition liquid LI stored in container 1.

Controller 50 issues a control instruction for at least one of the notification by alarm 51 and a laser beam emission operation based on the detection result of transmittance detection sensor 42. When the transmittance of transmission inhibition liquid LI detected by transmittance detection sensor 42 is greater than a predetermined value (for example, 10%/cm, 5%/cm, or 3%/cm), controller 50 issues the control instruction to execute the notification by alarm 51 or the control instruction to stop execution of the laser beam emission operation (or not to start the laser beam emission operation). For example, the notification by alarm 51 is performed by display or sound.

On the other hand, when the transmittance of transmission inhibition liquid LI detected by transmittance detection sensor 42 is less than or equal to a predetermined value (for example, 10%/cm, 5%/cm, or 3%/cm), controller 50 does not execute the notification by alarm 51, but issues the control instruction to start the laser beam emission operation.

Controller 50 controls the emission of the laser beam from laser head 10 to workpiece WO based on the detection result of liquid level sensor 45 and the detection result of transmittance detection sensor 42. Thus, the laser beam is emitted from laser head 10, and the processing of workpiece WO is started.

For example, controller 50 is a processor, and may be a central processing unit (CPU).

### <Functional Block of Controller>

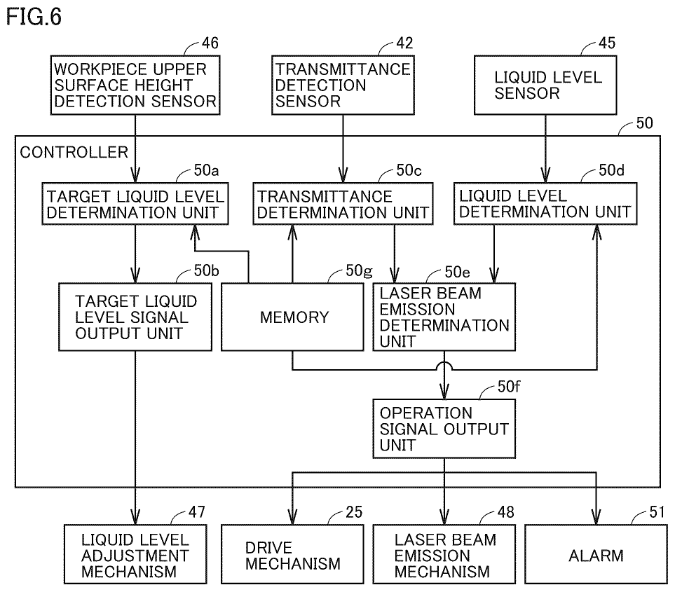

With reference to FIG. 6, a functional block of controller 50 in FIG. 5 will be described below.

FIG. 6 is a functional block diagram illustrating the controller in FIG. 5. As illustrated in FIG. 6, controller 50 includes a target liquid level determination unit 50a, a target liquid level signal output unit 50b, a transmittance determination unit 50c, a liquid level determination unit 50d, a laser beam emission determination unit 50e, an operation signal output unit 50f, and a memory 50g.

A workpiece upper surface height detection sensor 46 detects the upper surface height of workpiece WO placed on placement unit 2c. Workpiece upper surface height detection sensor 46 is a known sensor that obtains the distance between laser head 10 and workpiece WO by the capacitance between a nozzle 55 and workpiece WO. Controller 50 generates a signal indicating the upper surface height of workpiece WO based on the position in the height direction of laser head 10 and the distance between laser head 10 and workpiece WO obtained by workpiece upper surface height detection sensor 46.

Target liquid level determination unit 50a determines a target liquid level PL (FIG. 5) of transmission inhibition liquid LI stored in container 1 based on the signal indicating the upper surface height of workpiece WO. When determining target liquid level PL, target liquid level determination unit 50a refers to a height difference of the liquid level (the height difference from the upper surface of workpiece WO to the target liquid level) stored in memory 50g. Specifically, target liquid level determination unit 50a determines target liquid level PL of transmission inhibition liquid LI by adding the height difference of the liquid level stored in memory 50g to the upper surface height of workpiece WO detected by workpiece upper surface height detection sensor 46.

Target liquid level determination unit 50a outputs a signal indicating determined target liquid level PL to target liquid level signal output unit 50b. Target liquid level signal output unit 50b outputs a signal controlling liquid level adjustment mechanism 47 based on the acquired signal indicating target liquid level PL. Thus, liquid level adjustment mechanism 47 is controlled, and the liquid level of transmission inhibition liquid LI in container 1 is adjusted to target liquid level PL.

Controller 50 acquires a signal indicating the transmittance of transmission inhibition liquid LI detected by transmittance detection sensor 42. Based on the signal indicating the transmittance acquired from transmittance detection sensor 42, transmittance determination unit 50c determines whether the transmittance of acquired transmission inhibition liquid LI is less than or equal to a predetermined value.

When making the above determination, transmittance determination unit 50c refers to the predetermined value of the transmittance stored in memory 50g. As described above, for example, the predetermined value of the transmittance is 10%/cm, 5%/cm, or 3%/cm. Transmittance determination unit 50c outputs a signal indicating the determination result to laser beam emission determination unit 50e.

Controller 50 acquires a signal indicating the distance between the tip of liquid level sensor 45 and the liquid level of transmission inhibition liquid LI, the distance being detected by liquid level sensor 45. Liquid level determination unit 50d determines whether the liquid level of transmission inhibition liquid LI is located at a predetermined position with respect to laser head 10 based on the signal acquired from liquid level sensor 45. Thus, for example, it is determined whether laser head 10 is located below the liquid level of transmission inhibition liquid LI.

When making the above determination, liquid level determination unit 50d refers to the positional relationship between laser head 10 and the liquid level of transmission inhibition liquid LI during the laser processing stored in memory 50g. Specifically, liquid level determination unit 50d determines whether the height position of the liquid level of transmission inhibition liquid LI with respect to laser head 10 detected by liquid level sensor 45 satisfies a predetermined positional relationship between laser head 10 and the liquid level of transmission inhibition liquid LI stored in memory 50g. Liquid level determination unit 50d outputs a signal indicating the determination result to laser beam emission determination unit 50e.

Laser beam emission determination unit 50e determines whether to emit the laser beam based on the determination result of transmittance determination unit 50c and the determination result of liquid level determination unit 50d. Specifically, when both the determination result indicating that the transmittance of transmission inhibition liquid LI is less than or equal to a predetermined value and the determination result indicating that the height position of the liquid level of transmission inhibition liquid LI is in a predetermined positional relationship with respect to laser head 10 are acquired, laser beam emission determination unit 50e determines to emit the laser beam. When either the determination result that the transmittance of transmission inhibition liquid LI is larger than the predetermined value or the determination result that the height position of the liquid level of transmission inhibition liquid LI does not satisfy the predetermined positional relationship with respect to laser head 10 is acquired, laser beam emission determination unit 50e determines that the laser beam is not emitted.

Laser beam emission determination unit 50e outputs the signal indicating the determination result to operation signal output unit 50f. Operation signal output unit 50f outputs a signal controlling laser beam emission mechanism 48, alarm 51, and drive mechanism 25 based on the acquired signal indicating the determination result.

Specifically, operation signal output unit 50f controls laser beam emission mechanism 48 to emit the laser beam when acquiring the determination signal indicating the emission of the laser beam. For example, operation signal output unit 50f outputs a control command supplying current to a laser oscillator to laser beam emission mechanism 48.

When acquiring the determination signal indicating that the laser beam is not emitted, operation signal output unit 50f controls the laser beam emission mechanism 48 so as not to emit the laser beam. For example, operation signal output unit 50f outputs the control command not to supply the current to the laser oscillator to laser beam emission mechanism 48. When acquiring the determination signal indicating that the laser beam is not emitted, operation signal output unit 50f controls alarm 51 to perform the notification by display or sound that the transmittance of transmission inhibition liquid LI is larger than a predetermined value or that the height position of the liquid level of transmission inhibition liquid LI does not satisfy a predetermined positional relationship with respect to laser head 10.

When acquiring a determination signal indicating that the transmittance of transmission inhibition liquid LI is less than or equal to the predetermined value, operation signal output unit 50f controls drive mechanism 25 so that laser head 10 descends in the Z-direction to the height position of the processing start position.

For example, the laser beam emission mechanism includes a laser oscillator, a power supply, a cooling chiller, and the like.

### <Laser Processing Method>

With reference to FIGS. 5 to 8, a laser processing method using the laser processing device of the embodiment will be described below.

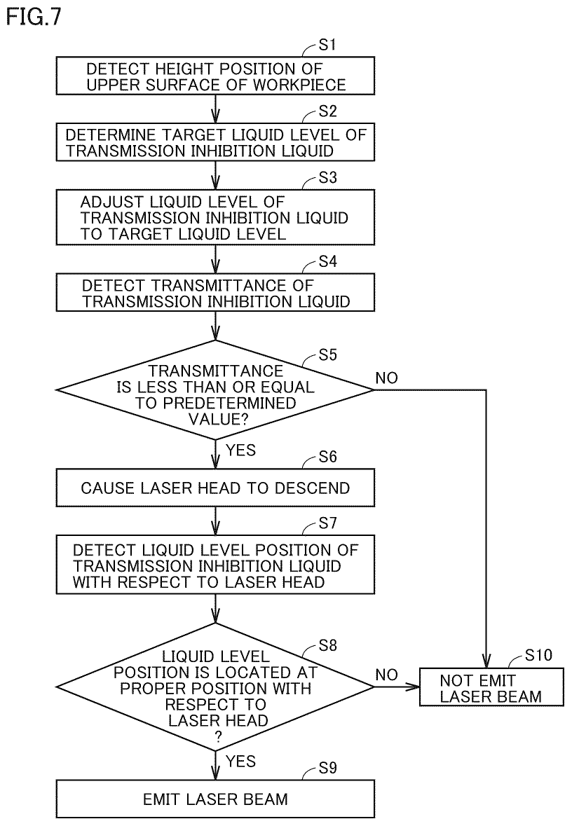

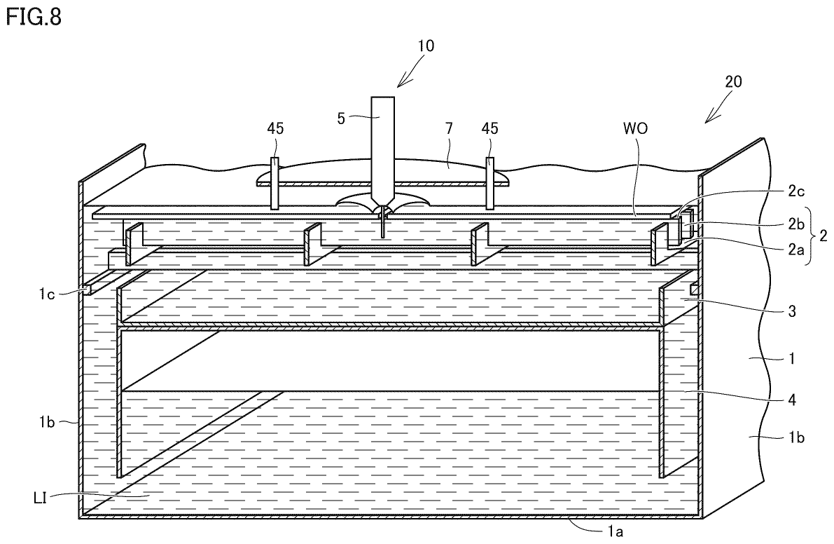

FIG. 7 is a flowchart illustrating the laser processing method of the embodiment. FIG. 8 is a sectional perspective view illustrating how the workpiece is subjected to laser processing.

As illustrated in FIG. 5, transmission inhibition liquid LI is supplied into container 1 of laser processing device 20. At this point, controller 50 controls to open supply valve 31. Thus, transmission inhibition liquid LI is supplied from supply pipe 36 into container 1. At this point, controller 50 detects the liquid level of transmission inhibition liquid LI in container 1 using liquid level detection sensor 41. When determining that the liquid level of transmission inhibition liquid LI in container 1 reaches a desired liquid level SL based on the detection result of liquid level detection sensor 41, controller 50 controls supply valve 31 to be closed. At this point, for example, transmission inhibition liquid LI is supplied to a position SL lower than height position HL of placement unit 2c of cutting pallet 2.

Workpiece WO is carried into laser processing device 20. Workpiece WO is disposed on placement unit 2c of cutting pallet 2. For example, workpiece WO is a steel material. In this state, the laser processing operation by laser processing device 20 is started.

For example, the laser processing operation in laser processing device 20 is started by operating processing start switch 52. When the laser processing operation is started, controller 50 adjusts the liquid level of transmission inhibition liquid LI stored in container 1 to a standby liquid level WL based on the detection result of liquid level detection sensor 41. Specifically, for example, controller 50 controls pressurizing valve 32 to open. Thus, the gas is supplied into liquid level adjustment tank 4, and the liquid level of transmission inhibition liquid LI stored in container 1 is adjusted to be high to standby liquid level WL.

Thereafter, laser head 10 moves in the X-, Y-directions to move directly above the processing start position. Thereafter, laser head 10 descends in the Z-direction toward workpiece WO. In the state where laser head 10 is lowered, the height position of the upper surface of workpiece WO is detected by workpiece upper surface height detection sensor 46 (FIG. 6) (step S1: FIG. 7).

As illustrated in FIG. 6, a signal indicating the height position of the upper surface of workpiece WO detected by workpiece upper surface height detection sensor 46 is acquired by controller 50. Target liquid level determination unit 50a of controller 50 determines target liquid level PL of transmission inhibition liquid LI based on the acquired height position of the upper surface of workpiece WO (step S2: FIG. 7).

As illustrated in FIG. 5, target liquid level PL is set at height position HL of placement unit 2c or above height position HL. In the embodiment, for example, target liquid level PL is set at a position higher than the upper surface of workpiece WO. After target liquid level PL is determined, laser head 10 moves upward in the Z-direction, and is separated from workpiece WO.

As illustrated in FIG. 6, when target liquid level PL is determined, target liquid level signal output unit 50b outputs a control signal to liquid level adjustment mechanism 47. Based on this control signal, liquid level adjustment mechanism 47 adjusts the liquid level of transmission inhibition liquid LI to target liquid level PL (step S3: FIG. 7).

As illustrated in FIG. 5, specifically, controller 50 controls to open, for example, pressurizing valve 32. Thus, the gas is supplied into liquid level adjustment tank 4, and the liquid level of transmission inhibition liquid LI stored in container 1 is adjusted to be high to target liquid level PL.

Target liquid level PL of transmission inhibition liquid LI is higher than height position HL of placement unit 2c. In the embodiment, for example, target liquid level PL of transmission inhibition liquid LI is adjusted to the position higher than the upper surface of workpiece WO. Thus, as illustrated in FIG. 8, entire workpiece WO sinks (is immersed) in transmission inhibition liquid LI.

As illustrated in FIG. 5, liquid level detection sensor 41 detects that the liquid level of transmission inhibition liquid LI reaches target liquid level PL. When acquiring a signal indicating that the liquid level of transmission inhibition liquid LI reaches target liquid level PL, controller 50 controls transmittance detection sensor 42 to detect the transmittance of transmission inhibition liquid LI (step S4: FIG. 7).

As illustrated in FIG. 6, transmittance detection sensor 42 detects the transmittance of transmission inhibition liquid LI. Controller 50 acquires a signal indicating the detected transmittance. Transmittance determination unit 50c of controller 50 determines whether the detected transmittance is less than or equal to a predetermined value (for example, 10%/cm, 5%/cm or 3%/cm) (step S5: FIG. 7). Transmittance determination unit 50c outputs the determination result to laser beam emission determination unit 50e.

When acquiring the determination result that the detected transmittance is larger than the predetermined value, laser beam emission determination unit 50e determines not to emit the laser beam. Laser beam emission determination unit 50e outputs a signal indicating the determination result to operation signal output unit 50f. Operation signal output unit 50f controls laser beam emission mechanism 48 such that laser beam emission mechanism 48 does not emit the laser beam (step S10: FIG. 7). In addition, operation signal output unit 50f controls alarm 51 to notify that the transmittance of transmission inhibition liquid LI is larger than a predetermined value by display or sound.

When acquiring a determination result that the detected transmittance is less than or equal to the predetermined value, laser beam emission determination unit 50e outputs a signal indicating the determination result to operation signal output unit 50f. Operation signal output unit 50f controls drive mechanism 25 such that laser head 10 descends in the Z-direction to the height position of the processing start position (step S6: FIG. 7).

When laser head 10 descends as described above, the distance between the tip of liquid level sensor 45 and the liquid level of transmission inhibition liquid LI is detected by liquid level sensor 45 (step S7: FIG. 7). A signal indicating the detection result of liquid level sensor 45 is acquired by liquid level determination unit 50d of controller 50.

Liquid level determination unit 50d determines whether the liquid level of transmission inhibition liquid LI is located at a predetermined position with respect to laser head 10 based on the signal acquired from liquid level sensor 45 (step S8: FIG. 7). Liquid level determination unit 50d outputs the determination result to laser beam emission determination unit 50e.

When acquiring the determination result that the liquid level of transmission inhibition liquid LI is not in the predetermined positional relationship with respect to laser head 10, laser beam emission determination unit 50e determines not to emit the laser beam. Laser beam emission determination unit 50e outputs a signal indicating the determination result to operation signal output unit 50f. Operation signal output unit 50f controls laser beam emission mechanism 48 such that laser beam emission mechanism 48 does not to emit the laser beam based on the acquired signal (step S10: FIG. 7). Based on the acquired signal, operation signal output unit 50f controls alarm 51 to notify laser head 10 that the liquid level of transmission inhibition liquid LI is not located at the predetermined position by display or sound.

When acquiring a determination result that the liquid level of transmission inhibition liquid LI is in the predetermined positional relationship with respect to laser head 10, laser beam emission determination unit 50e determines to emit the laser beam. As described above, when acquiring the determination result that the liquid level of transmission inhibition liquid LI is at the predetermined position with respect to laser head 10 after acquiring the determination result that the detected transmittance is less than or equal to the predetermined value, laser beam emission determination unit 50e determines to emit the laser beam. Laser beam emission determination unit 50e outputs a signal indicating the determination result to operation signal output unit 50f. Operation signal output unit 50f controls laser beam emission mechanism 48 to emit the laser beam based on the acquired signal (step S9: FIG. 7).

As illustrated in FIG. 8, the laser beam is emitted as described above, and laser processing is started. During the laser processing, workpiece WO is irradiated with the laser beam from laser head 10. Furthermore, the assist gas is blown from laser head 10 toward workpiece WO.

Transmission inhibition liquid LI is pushed away at a processing point of workpiece WO by blowing force of the assist gas. Thus, the upper surface of workpiece WO is exposed from transmission inhibition liquid LI at the processing point of workpiece WO.

The upper surface of workpiece WO exposed from transmission inhibition liquid LI is irradiated with the laser beam. Workpiece WO is processed by the irradiation with the laser beam. Thus, for example, workpiece WO is cut. The laser beam that penetrates workpiece WO by cutting workpiece WO enters transmission inhibition liquid LI stored below workpiece WO.

The assist gas blown out from laser head 10 is discharged to the outside from between the lower surface of laser beam shielding member 7 and the liquid surface of transmission inhibition liquid LI. Because of this, pressure of the gas is prevented from increasing between the lower surface of laser beam shielding member 7 and the liquid level of transmission inhibition liquid LI due to the blowing of the assist gas.

Sludge generated when workpiece WO is cut by the laser processing sinks into transmission inhibition liquid LI and accumulates in sludge tray 3. For example, the sludge is iron oxide particles in which molten iron is hardened. As described above, the laser processing is performed while workpiece WO is immersed in transmission inhibition liquid LI, whereby scattering of the sludge generated during the processing to the surroundings is prevented.

When the laser processing is ended, controller 50 controls laser head 10 to move to an initial position. Specifically, X-direction movable base 22 illustrated in FIG. 1 moves in the X-direction with respect to the pair of left and right support bases 21. Y-direction movable base 23 moves in the Y-direction with respect to X-direction movable base 22. Laser head 10 moves in the Z-direction with respect to Y-direction movable base 23.

As illustrated in FIG. 5, after laser head 10 moves to the initial position, the liquid level of transmission inhibition liquid LI is adjusted to the position lower than the lower surface of workpiece WO by adjusting the liquid level of transmission inhibition liquid LI. Thus, entire workpiece WO is exposed from transmission inhibition liquid LI.

Specifically, for example, controller 50 controls pressure reducing valve 33 to open after the detection of the end of the laser processing. Thus, the amount of gas stored in liquid level adjustment tank 4 is reduced, and transmission inhibition liquid LI flows into liquid level adjustment tank 4. Therefore, the liquid level of transmission inhibition liquid LI in container 1 is lowered. At this point, controller 50 detects the liquid level of transmission inhibition liquid LI in container 1 using liquid level detection sensor 41. When determining that the liquid level of transmission inhibition liquid LI in container 1 reaches the desired liquid level SL, controller 50 controls pressure reducing valve 33 to be closed.

After the liquid level of transmission inhibition liquid LI in container 1 reaches the predetermined liquid level SL, workpiece WO is carried out of laser processing device 20. As needed, cutting pallet 2 and sludge tray 3 are taken out of container 1. After that, the sludge in sludge tray 3 is removed.

As described above, the laser processing using laser processing device 20 of the embodiment is performed. Although the method for cutting workpiece WO has been described above as the laser processing method, the laser processing method may be a processing method such as welding using the laser beam.

### Advantageous Effect of Embodiment

An advantageous effect of the embodiment will be described below.

In the embodiment, as illustrated in FIG. 5, container 1 can store transmission inhibition liquid LI. For this reason, the laser beam processing workpiece WO enters transmission inhibition liquid LI after penetrating workpiece WO. Transmission inhibition liquid LI inhibits the transmission of the laser beam. Thus, the transmission of the laser beam entering transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, the leakage of the laser beam to the outside of laser processing device 20 is prevented only by storing transmission inhibition liquid LI in container 1. Thus, the light shielding member preventing the leakage of the laser beam is not required to be installed below workpiece WO. Accordingly, the leakage of the laser beam to the outside of laser processing device 20 is prevented with a simple structure.

In addition, the leakage of the laser beam is prevented without covering entire container 1 with a machine room like the machine room-type fiber laser processing device.

Transmission inhibition liquid LI may inhibit the transmission of the light having the wavelength greater than or equal to 0.7 μm and less than or equal to 10 μm. In this case, when the laser beam having the wavelength greater than or equal to 0.7 μm and less than or equal to 10 μm is used as the laser beam, the transmission of the laser beam incident into transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, using the fiber laser as the laser beam source, power consumption in the laser processing is reduced and a life is lengthened. The light of the fiber laser easily transmits water or the like as compared with the light of the carbon dioxide laser (wavelength of 10.6 μm). However, in the embodiment, because transmission inhibition liquid LI inhibits the transmission of the light having the wavelength greater than or equal to 0.7 μm and less than or equal to 10 μm as described above, even when the fiber laser is used as the laser beam source, the laser beam is prevented from leaking out of laser processing device 20.

In addition, the emission of the laser beam to workpiece WO by laser head 10 is controlled based on the detection results of transmittance detection sensor 42 and liquid level sensor 45. This reliably prevents the leakage of the laser beam to the outside of laser processing device 20.

In the embodiment, as illustrated in FIG. 7, container 1 can store transmission inhibition liquid LI at least up to height position HL of placement unit 2c. Consequently, the laser beam after penetrating workpiece WO can be more reliably prevented from leaking out of laser processing device 20.

In the embodiment, as illustrated in FIG. 4, liquid level sensor 45 is fixed to laser head 10. For this reason, liquid level sensor 45 can detect the position of the liquid level of transmission inhibition liquid LI with respect to laser head 10 by detecting the distance between the tip of liquid level sensor 45 and the liquid level of transmission inhibition liquid LI.

In the embodiment, as illustrated in FIG. 4, liquid level sensor 45 is fixed to laser head 10 with laser beam shielding member 7 interposed therebetween. Thus, the laser beam reflected from workpiece WO by laser beam shielding member 7 can be prevented from leaking out of laser processing device 20, and liquid level sensor 45 can be disposed away from laser head 10.

In the embodiment, as shown in FIGS. 5 and 7, target liquid level PL of transmission inhibition liquid LI in container 1 is determined based on the height position of the upper surface of workpiece WO (step S2), and the liquid level of transmission inhibition liquid LI is adjusted to become target liquid level PL (step S3). Thus, the liquid level of transmission inhibition liquid LI can be adjusted based on the height position of the upper surface of workpiece WO.

It should be considered that the disclosed embodiment is illustrative and non-restrictive in every respect. The scope of the present invention is defined by not the description above, but the claims, and it is intended that all modifications within the meaning and scope equivalent to the claims are included in the present invention.

### REFERENCE SIGNS LIST

1: container, la: bottom wall, 1b: side wall, 1c: pallet support, 2: cutting pallet, 2a: first support plate, 2b: second support plate, 2c: placement unit, 3: sludge tray, 4: liquid level adjustment tank, 5: head body, 5a: body, 5aa, 5ba: gas outlet, 5ab, 5bb: gas supply unit, 5b: outer nozzle, 6a: condensing lens, 7: laser beam shielding member, 10: laser head, 20: laser processing device, 21: support base, 22, 23: direction movable base, 25: drive mechanism, 30: operation panel, 31: supply valve, 32: pressurizing valve, 33: pressure reducing valve, 34: discharge valve, 35: liquid storage tank, 36: supply pipe, 37: gas pipe, 38: overflow pipe, 39: liquid discharge piping, 41: liquid level detection sensor, 42: transmittance detection sensor, 45: liquid level sensor, 46: workpiece upper surface height detection sensor, 47: liquid level adjustment mechanism, 48: laser beam emission mechanism, 50: controller, 50a: target liquid level determination unit, 50b: target liquid level signal output unit, 50c: transmittance determination unit, 50d: liquid level determination unit, 50e: laser beam emission determination unit, 50f: operation signal output unit, 50g: memory, 51: alarm, 52: processing start switch, LI: transmission inhibition liquid, WO: workpiece

1: A laser processing device processing a workpiece using a laser beam, the laser processing device comprising:
a container that can store a transmission inhibition liquid inhibiting transmission of the laser beam;
a laser head that emits the laser beam;
a transmittance detection sensor that detects transmittance of the transmission inhibition liquid stored in the container;
a liquid level sensor that is fixed to the laser head and detects a relative distance between the liquid level sensor and a liquid level of the transmission inhibition liquid; and
a controller that controls emission of the laser beam to the workpiece by the laser head based on detection results of the transmittance detection sensor and the liquid level sensor.

2: The laser processing device according to claim 1, further comprising a workpiece upper surface height detection sensor that detects a height position of an upper surface of the workpiece,
wherein the controller determines a target liquid level of the transmission inhibition liquid in the container based on the height position of the upper surface of the workpiece detected by the workpiece upper surface height detection sensor, and adjusts a liquid level of the transmission inhibition liquid in the container to the target liquid level.

3: The laser processing device according to claim 1, further comprising a support member that includes a placement unit supporting a lower surface of the workpiece,
wherein the container can store the transmission inhibition liquid at least up to a height position of the placement unit.

4: The laser processing device according to claim 1, further comprising a laser beam shielding member that surrounds a periphery of the laser head,
wherein the liquid level sensor is fixed to the laser head with the laser beam shielding member interposed between the liquid level sensor and the laser head.

5: A laser processing method for processing a workpiece placed on a placement unit in a container using a laser beam emitted from a laser head, the laser processing method comprising:
storing a transmission inhibition liquid inhibiting transmission of the laser beam in the container;
detecting transmittance of the transmission inhibition liquid stored in the container;
detecting a liquid level position of the transmission inhibition liquid with respect to the laser head; and
controlling emission of the laser beam to the workpiece by the laser head based on a detection result of the transmittance of the transmission inhibition liquid and a detection result of the liquid level position of the transmission inhibition liquid.

6: The laser processing method according to claim 5, further comprising:
detecting a height position of an upper surface of the workpiece placed on the placement unit;
determining a target liquid level of the transmission inhibition liquid in the container based on the detected height position of the upper surface of the workpiece; and
adjusting a liquid level of the transmission inhibition liquid in the container to the target liquid level,
wherein the liquid level position of the transmission inhibition liquid with respect to the laser head is detected after the liquid level of the transmission inhibition liquid is adjusted to the target liquid level.
